(19) United States
(12) Patent Application Publication
(10) Pub. No.: US 2021/0247597 A1
(43) Pub. Date: Aug. 12, 2021

(54) LENS SYSTEM AND IMAGE CAPTURING APPARATUS

(71) Applicant: VICTOR HASSELBLAD AB, Gotenborg (SE)

(72) Inventors: Yoshitaka AKASHI, Tokyo (JP); Atsushi OHATA, Tokyo (JP)

(21) Appl. No.: 17/238,176

(22) Filed: Apr. 22, 2021

(30) Foreign Application Priority Data
Apr. 24, 2020 (JP) 2020-077256

(51) Int. Cl. G02B 15/177; G02B 15/14; G02B 27/00; G02B 15/20

(52) U.S. Cl. CPC G02B 15/177; G02B 15/20; G02B 27/0025; G02B 15/144507

(57) ABSTRACT

A lens system includes a first lens group having a negative refractive power, a second lens group having a positive refractive power, a third lens group having a positive refractive power, and a fourth lens group having a negative refractive power. The first, second, third, and fourth lens groups are arranged in order from an object side of the lens system. During a change from focusing on a first object to focusing on a second object closer to the lens system than the first object, at least the second lens group and the third lens group move along an optical axis toward the object side. The lens system satisfies 0.7<|f4/f|<2.0, where f represents a focal length of the lens system, and f4 represents a focal length of the fourth lens group.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application claims priority to Japanese Patent Application No. 2020-077256, filed on Apr. 24, 2020, the entire content of which is incorporated herein by reference.

### TECHNICAL FIELD

The present disclosure relates to a lens system and an image capturing apparatus.

### BACKGROUND

Patent Document 1 discloses an optical system comprising a front lens group that has a negative refractive power and is immovable during focusing and a rear lens group that has a positive refractive power and moves during focusing, which are in order from an object side. Patent Document 2 discloses a photographic lens, comprising: a positive lens group, a negative lens group that moves during focusing, a positive lens group that moves during focusing, a negative lens group that can move in a direction substantially vertical to an optical axis, and a positive lens group, which are in order from an object side.

### [Patent Document 1] JP-A-2014-085429

### [Patent Document 2] JP-A-2009-175202

### SUMMARY

The lens system according to an aspect of the present disclosure comprises: a first lens group having a negative refractive power, a second lens group having a positive refractive power, a third lens group having a positive refractive power, and a fourth lens group having a negative refractive power, which are in order from an object side. During focusing from an object at infinity to an object at close range, at least the second lens group moves on an optical axis toward the object side and the third lens group moves on the optical axis toward the object side. The conditional expression

0.7<|f4/f|<2.0

is satisfied, where f represents the focal length of the entire system, and f4 represents the focal length of the fourth lens group.

A cemented lens may be arranged in the second lens group and the third lens group. The conditional expression

0.9<f2/f<2.0

0.5<f3/f<1.4

may be satisfied, where f2 represents the focal length of the second lens group, and f3 represents the focal length of the third lens group.

An aspherical lens having a negative refractive power may be arranged in the first lens group and the fourth lens group. The conditional expression

1.0<|f_1asp/f|<2.5

0.6<|f_4asp/f|<2.2

may be satisfied, where f_1asp represents the focal length of the aspherical lens of the first lens group, and f_4asp represents the focal length of the aspherical lens of the fourth lens group.

An aspherical lens having a negative refractive power may be arranged in the first lens group and the fourth lens group. The conditional expressions

0.5<d_1asp/f<0.95

0.4<d_4asp/f<0.95

may be satisfied, where d_1asp represents the distance from a stop to the aspherical lens of the first lens group, and d_4asp represents the distance from the stop to the aspherical lens of the fourth lens.

The conditional expression

2.4<TL/Y<3.6

may be satisfied, where TL represents the distance on the optical axis from the lens surface, of the first lens group, closest to the object side to an imaging plane during focusing on an object at infinity (the back focal length is an air conversion length), and Y represents the maximum image height.

1.0<EPD/Y<1.7

may be satisfied, where EPD represents an exit pupil distance, and Y represents the maximum image height.

The image capturing apparatus according to an aspect of the present disclosure comprises the above lens system. The image capturing apparatus comprises an image sensor.

According to the above lens system, it is possible to provide a lens system having a large image circle, a short overall length, and a high performance.

Incidentally, the above summary of the disclosure does not enumerate all the necessary features of the present disclosure. In addition, sub-combinations of groups of features may also be disclosures.

### BRIEF DESCRIPTION OF THE DRAWINGS

FIG. 1 shows the lens configuration of a lens system 100 according to Example 1, together with an optical member P and an image plane IM.

FIG. 2 shows spherical aberration, astigmatism, and distortion of the lens system 100 in the infinity focusing state.

FIG. 3 shows the lens configuration of a lens system 200 according to Example 2, together with an optical member P and an image plane IM.

FIG. 4 shows spherical aberration, astigmatism, and distortion of the lens system 200 in the infinity focusing state.

FIG. 5 shows the lens configuration of a lens system 300 according to Example 3, together with an optical member P and an image plane IM.

FIG. 6 shows spherical aberration, astigmatism, and distortion of the lens system 300 in the infinity focusing state.

FIG. 7 shows an example of an external perspective view of an image capturing apparatus 2000 comprising the lens system according to the disclosure.

FIG. 8 is a diagram showing a functional block of the image capturing apparatus 2000.

### DESCRIPTION OF THE EMBODIMENTS

Hereinafter, the present disclosure will be explained through embodiments of the disclosure, but the following embodiments are not intended to limit the disclosure. In addition, all combinations of features explained in the embodiments are not necessarily indispensable for the solution means of the disclosure. It will be apparent to a person skilled in the art that various modifications or improvements can be made with regard to the following embodiments. It is apparent from the description that embodiments with such modifications or improvements can be included in the technical scope of the present disclosure.

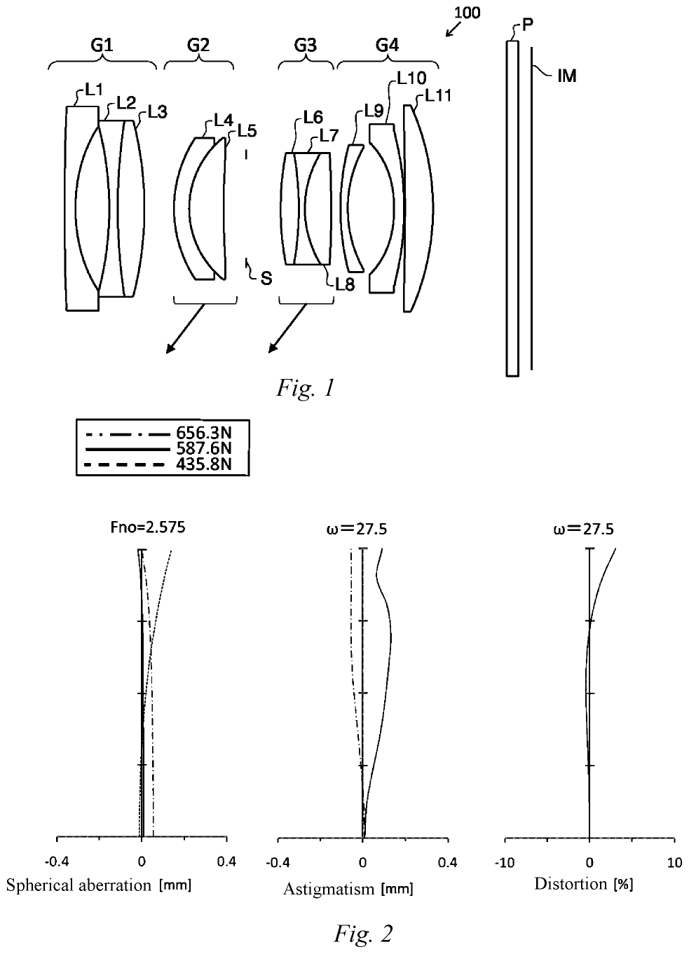

Examples of a lens system are disclosed in conjunction with FIGS. 1 to 6. As disclosed in each example, a lens system of one embodiment comprises: a first lens group having a negative refractive power, a second lens group having a positive refractive power, a third lens group having a positive refractive power, and a fourth lens group having a negative refractive power, which are in order from an object side. In the lens system, during focusing from an object at infinity to an object at close range, at least the second lens group moves on an optical axis toward the object side and the third lens group moves on the optical axis toward the object side. The lens system is an inner focus type lens. The following conditional expression (1) is satisfied:

0.7<|f4/f|<2.0 (1),

where f represents the focal length of the entire system, and f4 represents the focal length of the fourth lens group.

With the above configuration, through the divergence of light rays by means of the fourth lens group f4, the correction of the axial aberration and off-axis aberration on the each surface can be efficiently shared while maintaining a short back focal length with respect to the size of an image sensor. Further, in a lens configuration having a short back focal length, the angle of incidence on each lens surface becomes large, and the amount of aberration generated increases due to the difference in declination that occurs when light enters and exits from the lens, and the aberration tends to increase in various places. With respect to this, by providing aspherical lenses in the first lens group and the fourth lens group, which are fixed groups, it is possible to efficiently correcting the aberration on an aspherical surface while suppressing each aberration.

The conditional expression (1) defines the ratio of the refractive power of the fourth lens group to the entire lens. If the ratio is greater or equal to the upper limit of the conditional expression (1), the refractive power of the fourth lens group becomes relatively weak, which leads to an increase in the size of the lens system. If an attempt is made to improve the performance while reducing the size of the lens system, the sensitivity of each lens becomes high and the manufacturing difficulty increases. On the contrary, if the ratio is equal to or less than the lower limit of the conditional expression (1), the refractive power of the fourth lens group becomes relatively strong and contributes to miniaturization, but it becomes difficult to correct off-axis aberrations.

Further, the above-mentioned effect becomes more remarkable by satisfying the following conditional expression (1-1).

0.9<|f4/f|<1.6 (1-1)

In the selection of the focus lens group, when the first lens group is selected as the focus lens group, the weight of the focus lens group increases. When the final fourth lens group is selected as the focus lens group, the size of the focus lens group increases in proportion to the size of the image sensor because the fourth lens group is the front lens group of the image sensor. Therefore, in the present lens system, the group inside the lens is used as the focus group. In addition, in order to maintain a high focus performance from infinity to close range, floating focus is used as the focus method. The configuration of the focus group can maintain a high focus performance by symmetrically arranging the second lens group having a positive refractive power and the third lens group having a positive refractive power with respect to a stop.

The cemented lens is arranged in the second lens group and the third lens group, and the following conditional equations (2) and (3) are satisfied:

0.9<f2/f<2.0 (2)

0.5<f3/f<1.4 (3),

where f2 represents the focal length of the second lens group, and f3 represents the focal length of the third lens group.

Conditional expressions (2) and (3) define the relationship between the focal length of the entire lens system and the focal length of the focus group. In the conditional expressions (2) and (3), if the ratio is greater or equal to the upper limit of the conditional expression, it is advantageous for correcting the aberration, but the focus sensitivity becomes weak, the speed during auto focus is slow, and it becomes difficult to perform quick focusing. In addition, it becomes difficult to reduce the overall length. If the ratio is equal to or less than the lower limit of the conditional expression, the refractive power becomes too strong, so that it becomes difficult to correct the aberration generated off-axis, and the performance deterioration due to the eccentricity error becomes large.

An Aspherical lens having a negative refractive power is arranged in the first lens group and the fourth lens group, and the following conditional equations (4) and (5) are satisfied:

1.0<|f_1asp/f|<2.5 (4)

0.6<|f_4asp/f|<2.2 (5),

where f_1asp represents the focal length of the aspherical lens of the first lens group, and f_4asp represents the focal length of the aspherical lens of the fourth lens group.

The conditional equations (4) and (5) define the relationship between the focal length of the entire lens system and the focal length of the aspherical lenses arranged in the fixed group. In the conditional expressions (4) and (5), if the ratio is greater or equal to the upper limit of the conditional expression, it is advantageous for correcting the aberration correction, but the refractive power of each group becomes relatively weak, which leads to an increase in the size of the lens. On the contrary, if the ratio is equal to or less than the lower limit of the conditional expression, the refractive power of the aspherical lens in each group becomes too strong, and it becomes difficult to correct the aberration. In addition, the sensitivity of the aspherical lens becomes high, and the manufacturing difficulty increases.

An aspherical lens each having a negative refractive power is arranged in the first lens group and the fourth lens group, and the conditional equations (6) and (7) are satisfied:

0.5<d_1asp/f<0.95 (6)

0.4<d_4asp/f<0.95 (7),

where d_1asp represents the distance from the stop to the aspherical lens of the first lens group, and d_4asp represents the distance from the stop to the aspherical lens of the fourth lens.

The conditional expressions (6) and (7) define the positional relationship between the stop position and the aspherical lenses arranged in the fixed group. If the ratio is greater than or equal to the upper limit of the conditional expression, it is advantageous for correcting the aberration of the peripheral image height, but the diameter of the lens becomes large, which causes an increase in the size of the entire lens system and an increase in manufacturing cost. On the contrary, if the ratio is less than or equal to the lower limit of the conditional expression, it becomes disadvantageous for correcting the aberration of the peripheral image height and it becomes difficult to maintain the aberration performance.

The following conditional expression (8) is satisfied:

2.4<TL/Y<3.6 (8),

where TL represents the distance on the optical axis from the lens surface, of the first lens group, closest to the object side to an imaging plane during focusing on an object at infinity (i.e., the back focal length of the lens system in the air (an air conversion length)), and Y represents the maximum image height.

The conditional expression (8) defines the relationship between the overall lens length and the maximum image height during focusing on a subject at infinity. If the ratio is greater than or equal to the upper limit of the conditional expression, it is advantageous for correcting the aberration, but it becomes difficult to shorten the overall length of the system. On the contrary, if the ratio is less than or equal to the lower limit of the conditional expression, the overall length of the system becomes shorter than the maximum image height, and it becomes difficult to maintain the aberration performance.

Further, the above-mentioned effect becomes more remarkable by satisfying the following conditional expression (8-1).

2.7<TL/Y<3.1 (8-1)

The following conditional expression (9) is satisfied:

1.0<EPD/Y<1.7 (9),

where EPD represents an exit pupil distance, and Y represents the maximum image height.

The conditional expression (9) defines the relationship between the exit pupil position and the maximum image height during focusing on a subject at infinity. If the ratio is greater than or equal to the upper limit of the conditional expression, the exit pupil position becomes far from the image capturing surface, and it becomes difficult to shorten the overall length of the lens system. On the contrary, if the ratio is less than or equal to the lower limit of the conditional expression, since the exit pupil position is too small with respect to the maximum image height, the angle of incidence of the off-axis light rays becomes large, and off-axis aberration is likely to occur. In addition, because of the deviation of the angle of incidence of the image sensor, the peripheral dimming is caused.

Further, the above-mentioned effect becomes more remarkable by satisfying the following conditional expression (9-1).

1.3<EPD/Y<1.5 (9-1)

As described above, according to the above lens system, it is possible to provide a lens system having a large image circle, a short overall length, and a high performance. Further, it is possible to provide a lens system in which the movable lens group is lightweight and focusing can be performed at high speed.

Moreover, when the terms “composed of,” “consisting of,” and “consist of” are used in the present specification and the like, in addition to the listed elements, lenses, stops and filters that substantially do not have refractive power, and optical elements other than lenses that substantially have refractive power, such as cover glasses, and/or mechanical elements such as a lens flange, an image sensor and a shake correction mechanism and the like can be included.

In the following, an example, in which specific numerical values are applied to, in the specific embodiment of the lens system will be described. First, the meanings of symbols and the like used in the description of each example of the lens system will be described.

As lens data, a table showing the surface number, radius of curvature, surface spacing, refractive index and Abbe number is disclosed. In the table of the lens data, the surface number column shows the surface number when the surface closest to the object side is taken as the first surface and the number is increased one by one toward the image side. In column R, the radius of curvature of each surface is shown. In column D, the surface spacing between each surface and the surface adjacent to the image side on the optical axis is shown. Moreover, in column Nd the refractive index of each optical element with respect to the d-line (wavelength 587.6 nm (nanometer)) is shown, and in column Vd, the Abbe number based on the d-line standard of each optical element is shown. Here, the sign of the radius of curvature is positive when the surface shape is convex toward the object side and negative when the surface shape is convex toward the image plane side. “INF” in the radius of curvature indicates that the surface is flat.

The lens data also includes the aperture stop S. The expression “STO” is shown in the column of the surface number of the surface corresponding to the aperture stop S.

In the lens data, the surface number of an aspherical surface is marked with *, and the radius of curvature column shows the numerical value of the paraxial radius of curvature. Further, regarding the examples of the lens system having an aspherical surface, a table of aspherical data including the surface number of the aspherical surface, the aspherical coefficient for each aspherical surface, and the conic constant is attached. In the table of aspherical data, the numerical value “E±n” (n: natural number) of the aspherical coefficient is expressed as an exponent for a base of 10. That is, “E±n” means “x10^{±n}.” For example, “0.12345E-05” means “0.12345×10⁻⁵.” The aspherical shape is defined by the following equation:

zd=ch²/(1+(1−(1+κ)c²h²)^{1/2})+ΣAm×h^{m},

where “zd” represents the distance (sag amount) in an optical axis direction from the apex of the lens surface, “h” represents the distance (height) in the direction perpendicular to the optical axis direction, “C” represents the paraxial curvature at the apex of the lens (the reciprocal of the radius of curvature), and “κ” represents the conic constant, and “Am” represents an n-th order aspherical surface coefficient. In addition, Σ represents the sum of m.

In addition, a table of specification data of the lens system of each example is attached. In the table of the specification data, “f” represents the focal length. “Fno” represents the F number. “ω” of represents the half-angle of view (maximum half-angle of view). “Y” represents the maximum image height. “Dex” represents the exit pupil distance during focusing on a subject at infinity.

In the table of the lens data, changing surface spacing data, and the specification data of the lens system, “degree” is used as the unit of angle, and “mm” is used as the unit of length. However, since the lens system can be used even if it is proportionally expanded or contracted, any other unit can be used.

Moreover, in some embodiments, when the lens system is mounted on an image capturing apparatus as an image capturing lens, the lens system can comprise, corresponding to the specifications of the image capturing apparatus, various filters such as a low-pass filter and optical elements such as a cover glass for protection. The lens system of the disclosure may comprise or not comprise such an optical element. It can be said that a lens system comprising such an optical element and a lens system not comprising such an optical element are equivalent lens systems.

“Gi” represents a lens group. The i following the letter G in “Gi” is a natural number for the purpose of identifying lens groups comprised in the lens system in each example. A lens group is configured to comprise one or more lenses. “Lj” represents one lens. In “Lj,” the j following the letter L is a natural number for the purpose of identifying lenses included in the lens system in each example. In the description of each example, it does not mean that the lens to which the symbol Lj is assigned and the lens to which the same symbol Lj is assigned in the other examples are the same lens. Similarly, it does not mean that the lens or lens group to which a specific symbol is assigned in one example and the lens or lens group to which the same symbol is assigned in another example are the same lens or lens group.

FIG. 1 shows the lens configuration of a lens system 100 according to Example 1, together with an optical member P and an image plane IM.

The lens system 100 includes a first lens group G1 having a negative refractive power, a second lens group G2 having a positive refractive power, an aperture stop S, a third lens group G3 having a positive refractive power, and a fourth lens group G4 having a negative refractive power, which are in order from an object side.

Focusing is performed by moving the second lens group G2 and the third lens group G3 which serve as movable groups. The arrows associated with the second lens group G2 and the third lens group G3 represent the movement of the second lens group G2 and the third lens group G3, which serve as movable groups when focusing on a subject at close range from a subject at infinity.

The first lens group G1 includes a negative meniscus lens L1 having a convex surface facing the object side, a biconcave negative lens L2, and a biconvex positive lens L3 which is a cemented lens having a positive refractive power. By distributing the negative refractive power necessary for wide-angle lensing to at least one lens of two negative components, off-axis aberration is favorably corrected.

The second lens group G2 includes a negative meniscus lens L4 having a convex surface facing the object side and a positive lens L5 which is a cemented lens having a positive refractive power. The refractive power necessary for the second lens group G2 can be covered by one lens group, and axial aberration and off-axis aberration can be corrected in good balance.

The third lens group G3 includes three laminated lenses, namely, a biconvex positive lens L6, a biconcave negative lens L7, and a biconvex positive lens L8. By forming the third lens group G3 with three laminated lenses, eccentricity error sensitivity during movement can be reduced.

The fourth lens group G4 includes a negative meniscus lens L9 having a convex surface facing the object side, a negative meniscus lens L10 having a concave surface facing an object surface, and a positive meniscus lens L11 having a concave surface facing the object side.

Table 1 shows lens data of the lens system 100. Table 2 is a table showing aspherical data of the lens system 100.

TABLE 1

| Surface | | | | |
|---|---|---|---|---|
| number | R | D | Nd | Vd |
| 1* | 500.000 | 1.800 | 1.59201 | 67.02 |
| 2* | 28.993 | 5.566 | | |
| 3 | −54.037 | 1.400 | 1.72825 | 28.32 |
| 4 | 95.926 | 4.400 | 2.00100 | 29.13 |
| 5 | −57.773 | 4.879 | | |
| 6 | 21.266 | 2.500 | 1.85451 | 25.15 |
| 7 | 15.065 | 5.700 | 1.55032 | 75.50 |
| STO | 168.948 | 1.416 | | |
| 9 | INF | 2.250 | | |
| 10 | INF | 2.857 | | |
| 11 | INF | 2.838 | | |
| 12 | 48.672 | 3.000 | 2.05080 | 26.94 |
| 13 | −53.758 | 1.000 | 1.72835 | 28.32 |
| 14 | 17.562 | 4.300 | 1.72916 | 54.67 |
| 15 | −250.357 | 1.566 | | |
| 16 | 40.790 | 1.200 | 1.58913 | 61.25 |
| 17 | 20.818 | 7.648 | | |
| 18* | −22.1593 | 1.600 | 1.83441 | 37.29 |
| 19* | −81.0870 | 0.200 | | |
| 20 | −500.0000 | 4.600 | 1.80420 | 46.50 |
| 21 | −41.4342 | 0.100 | | |
| 22 | INF | 12.100 | | |
| 23 | INF | 1.850 | 1.51680 | 64.20 |
| 24 | INF | 2.230 | | |

TABLE 2

| Surface | | | |
|---|---|---|---|
| number | K | A4 | A6 |
| 1 | 0 | −9.86253E−09 | 3.95572E−11 |
| 2 | 0 | 1.03074E−05 | 1.19505E−09 |
| 18 | 0 | −1.13827E−04 | 4.92130E−07 |
| 19 | 0 | −8.01257E−05 | 6.76773E−07 |
| | Surface | | |
| | number | A8 | A10 |
| | 1 | −4.36543E−14 | 0.00000E+00 |
| | 2 | 1.52842E−11 | 1.31789E−13 |
| | 18 | −4.38576E−10 | −1.26667E−11 |
| | 19 | −2.68794E−09 | 4.59938E−12 |

Table 3 is a table of specification data showing the focal length f, F number Fno, half-angle of view ω, image height Y, and exit pupil distance Dex of the entire system of the lens system 100 during focusing on a subject at infinity.

TABLE 3

| | |
|---|---|
| f | 37.00 |
| Fno | 2.575 |
| ω | 27.52 |
| Y | 27.5 |
| Dex | −39.260 |

FIG. 2 shows spherical aberration, astigmatism, and distortion of the lens system 100 in a state of being in focus on a subject at infinity. In the spherical aberration diagram, a dot-dash line indicates the c-line (656.27 nm) value, a solid line indicates the d line (587.56 nm) value, and a dashed line indicates the g line (435.84 nm) value. In the astigmatism diagram, a solid line indicates the d-line sagittal image plane value, and a dashed line indicates the d-line meridional image plane value. In the distortion diagram, the d-line value is shown. Each of these aberration diagrams makes clear that the various aberrations can be favorably corrected in the lens system 100, and that the lens system 100 can provide superior imaging performance.

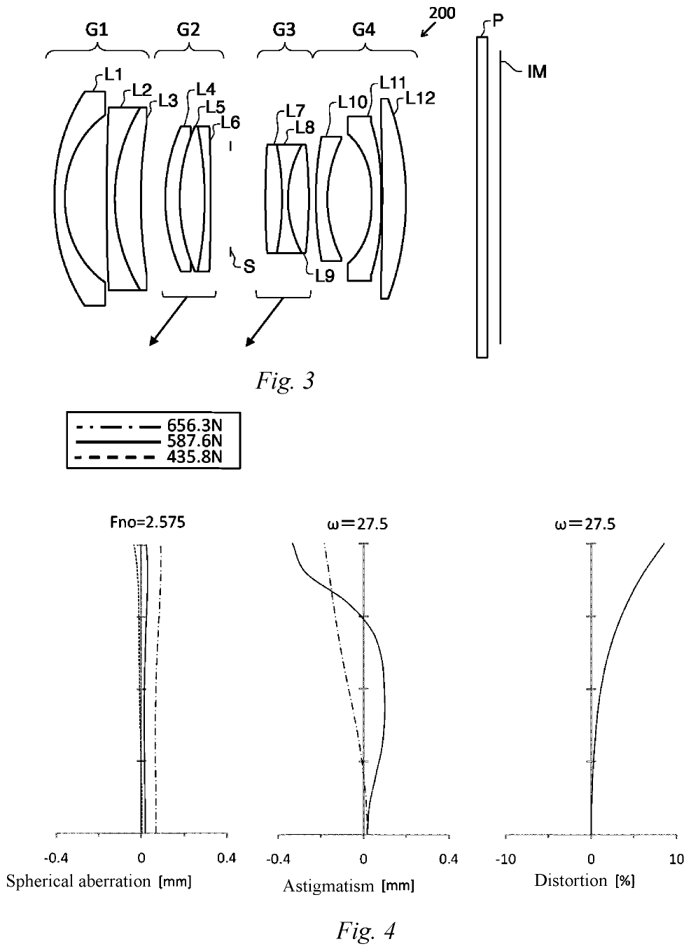

FIG. 3 shows the lens configuration of a lens system 200 according to Example 2, together with an optical member P and an image plane IM.

The lens system 200 includes a first lens group G1 having a negative refractive power, a second lens group G2 having a positive refractive power, an aperture stop S, a third lens group G3 having a positive refractive power, and a fourth lens group G4 having a negative refractive power, which are in order from an object side.

Focusing is performed by moving the second lens group G2 and the third lens group G3 which serve as movable groups. The arrows associated with the second lens group G2 and the third lens group G3 represent the movement of the second lens group G2 and the third lens group G3, which serve as movable groups when focusing on a subject at close range from a subject at infinity.

The first lens group G1 includes a negative meniscus lens L1 having a convex surface facing the object side, a negative meniscus lens L2 having a convex surface facing the object side, and a positive lens L3 which is a cemented lens having a positive refractive power. By distributing the negative refractive power necessary for wide-angle lensing to at least one lens of two negative components, off-axis aberration is favorably corrected.

The second lens group G2 includes three laminated lenses, namely, a negative meniscus lens L4 having a convex surface facing an object surface, a biconvex positive lens L5, and a negative meniscus lens L6 having a concave surface facing the object surface. By forming the third lens group G2 with three laminated lenses, eccentricity error sensitivity during movement can be reduced.

The third lens group G3 includes three laminated lenses, namely, a biconvex positive lens L7, a biconcave negative lens L8, and a biconvex positive lens L9. By forming the third lens group G3 with three laminated lenses, eccentricity error sensitivity during movement can be reduced.

The fourth lens group G4 includes a negative meniscus lens L10 having a convex surface facing the object side, a negative meniscus lens L11 having a concave surface facing the object surface, and a positive meniscus lens L12 having a concave surface facing the object side.

Table 4 shows lens data of the lens system 200. Table 5 is a table showing aspherical data of the lens system 200.

TABLE 4

| Surface | | | | |
|---|---|---|---|---|
| number | R | D | Nd | Vd |
| 1* | 43.461 | 1.800 | 1.592014 | 67.0227 |
| 2* | 21.481 | 6.223 | | |
| 3 | 352.745 | 1.400 | 1.69895 | 30.05050001 |
| 4 | 30.535 | 4.500 | 2.001 | 29.134 |
| 5 | 86.102 | 4.202 | | |
| 6 | 30.462 | 2.500 | 1.834807 | 42.7215 |
| 7 | 31.499 | 4.300 | 1.696802 | 55.4597 |
| STO | −65.131 | 1.000 | 1.808089 | 22.7643 |
| 9 | −500.0000 | 1.200 | | |
| 10 | INF | 2.250 | | |
| 11 | INF | 2.857 | | |
| 12 | INF | 3.143 | | |
| 13 | 137.481 | 2.900 | 2.0508 | 26.942 |
| 14 | −47.107 | 1.000 | 1.75211 | 25.0476 |
| 15 | 19.435 | 3.600 | 1.883 | 40.8054 |
| 16 | −82.448 | 1.200 | | |
| 17 | 58.932 | 2.000 | 1.496997 | 81.6084 |
| 18 | 23.1535 | 7.659 | | |
| 19* | −31.5595 | 1.600 | 1.83441 | 37.28510001 |
| 20* | −377.7392 | 0.200 | | |
| 21 | −500.0000 | 4.100 | 1.883 | 40.8054 |
| 22 | −49.5708 | 0.100 | | |
| 23 | INF | 12.100 | | |
| 24 | INF | 1.850 | 1.516798 | 64.1983 |
| 25 | INF | 2.230 | | |

TABLE 5

| Surface | | | |
|---|---|---|---|
| number | K | A4 | A6 |
| 1 | 0 | 2.17045E−05 | −8.51987E−08 |
| 2 | 0 | 3.10289E−05 | −4.81422E−08 |
| 19 | 0 | −1.87429E−04 | 7.91882E−07 |
| 20 | 0 | −1.46846E−04 | 1.07631E−06 |
| | Surface | | |
| | number | A8 | A10 |
| | 1 | 2.10898E−10 | −2.00286E−13 |
| | 2 | 4.64381E−11 | 6.85531E−13 |
| | 19 | −7.31141E−10 | −1.60621E−11 |
| | 20 | −4.10335E−09 | 6.68216E−12 |

Table 6 is a table of specification data showing the focal length f, F number Fno, half-angle of view ω, image height Y, and exit pupil distance Dex of the entire system of the lens system 200 during focusing on a subject at infinity.

TABLE 6

| | |
|---|---|
| f | 37.00 |
| Fno | 2.575 |
| ω | 27.52 |
| Y | 27.5 |
| Dex | −38.925 |

FIG. 4 shows spherical aberration, astigmatism, and distortion of the lens system 200 in a state of being in focus on a subject at infinity. In the spherical aberration diagram, a dot-dash line indicates the c-line (656.27 nm) value, a solid line indicates the d line (587.56 nm) value, and a dashed line indicates the g line (435.84 nm) value. In the astigmatism diagram, a solid line indicates the d-line sagittal image plane value, and a dashed line indicates the d-line meridional image plane value. In the distortion diagram, the d-line value is shown. Each of these aberration diagrams makes clear that the various aberrations can be favorably corrected in the lens system 200, and that the lens system 200 can provide superior imaging performance.

FIG. 5 shows the lens configuration of a lens system 300 according to Example 3, together with an optical member P and an image plane IM.

The lens system 300 includes a first lens group G1 having a negative refractive power, a second lens group G2 having a positive refractive power, an aperture stop S, a third lens group G3 having a positive refractive power, and a fourth lens group G4 having a negative refractive power, which are in order from an object side.

Focusing is performed by moving the second lens group G2 and the third lens group G3 which serve as movable groups. The arrows associated with the second lens group G2 and the third lens group G3 represent the movement of the second lens group G2 and the third lens group G3, which serve as movable groups when focusing on a subject at close range from a subject at infinity.

The first lens group G1 includes a negative meniscus lens L1 having a convex surface facing the object side, a biconcave negative lens L2, and a biconvex positive lens L3 which is a cemented lens having a positive refractive power. By distributing the negative refractive power necessary for wide-angle lensing to at least one lens of two negative components, off-axis aberration is favorably corrected.

The second lens group G2 includes a negative meniscus lens L4 having a convex surface facing an object surface and a positive lens L5 having two convex surfaces which is a cemented lens having a positive refractive power. The refractive power necessary for the second lens group G2 can be covered by one lens group, and axial aberration and off-axis aberration can be corrected in good balance.

The third lens group G3 includes a biconvex positive lens L8 and laminated lenses, namely, a biconvex positive lens L6, a biconcave negative lens L7. By separating one lens from the three-lens laminated configuration of the third lens group of Example 1, off-axis aberration can be favorably corrected and eccentricity error sensitivity during movement can be reduced.

The fourth lens group G4 includes a negative meniscus lens L9 having a convex surface facing the object side, a negative meniscus lens L10 having a concave surface facing an object surface, and a positive meniscus lens L11 having a concave surface facing the object side.

Table 7 shows lens data of the lens system 300. Table 8 is a table showing aspherical data of the lens system 300.

TABLE 7

| Surface | | | | |
|---|---|---|---|---|
| number | R | D | Nd | Vd |
| 1* | 500.000 | 1.800 | 1.5920 | 67.02 |
| 2* | 31.501 | 4.939 | | |
| 3 | −64.883 | 1.400 | 1.5927 | 35.45 |
| 4 | 71.893 | 6.200 | 2.0010 | 29.13 |
| 5 | −111.533 | 5.437 | | |
| 6 | 21.510 | 2.100 | 1.9212 | 23.96 |
| 7 | 16.079 | 5.900 | 1.4970 | 81.61 |
| STO | −127.1086 | 1.200 | | |
| 9 | INF | 2.250 | | |
| 10 | INF | 2.857 | | |
| 11 | INF | 2.428 | | |
| 12 | 29.511 | 3.100 | 1.9537 | 32.32 |
| 13 | −76.738 | 1.000 | 1.7521 | 25.05 |
| 14 | 22.022 | 2.000 | | |
| 15 | 33.834 | 3.200 | 1.8830 | 40.81 |
| 16 | −122.900 | 1.200 | | |
| 17 | 500.0000 | 0.700 | 1.6177 | 49.82 |
| 18 | 27.3559 | 7.509 | | |
| 19* | −18.0246 | 1.400 | 1.8344 | 37.29 |
| 20* | −44.8404 | 0.100 | | |
| 21 | −500.0000 | 4.000 | 1.9108 | 35.25 |
| 22 | −45.2320 | 0.100 | | |
| 23 | INF | 12.100 | | |
| 24 | INF | 1.850 | 1.5168 | 64.20 |
| 25 | INF | 2.230 | | |

TABLE 8

| Surface | | | |
|---|---|---|---|
| number | K | A4 | A6 |
| 1 | 0 | 2.17408E−06 | −1.29284E−08 |
| 2 | 0 | 1.20453E−05 | −1.20814E−09 |
| 19 | 0 | −3.63163E−05 | 1.84045E−07 |
| 20 | 0 | −1.48867E−05 | 2.42080E−07 |
| | Surface | | |
| | number | A8 | A10 |
| | 1 | 2.66020E−11 | −2.59919E−14 |
| | 2 | 2.68445E−11 | −1.30137E−14 |
| | 19 | −2.23102E−10 | −4.31633E−12 |
| | 20 | −8.78386E−10 | 1.26419E−12 |

Table 9 is a table of specification data showing the focal length f, F number Fno, half-angle of view ω, image height Y, and exit pupil distance Dex of the entire system of the lens system 300 during focusing on a subject at infinity.

TABLE 9

| | |
|---|---|
| f | 37.00 |
| Fno | 2.575 |
| ω | 27.86 |
| Y | 27.5 |
| Dex | −38.504 |

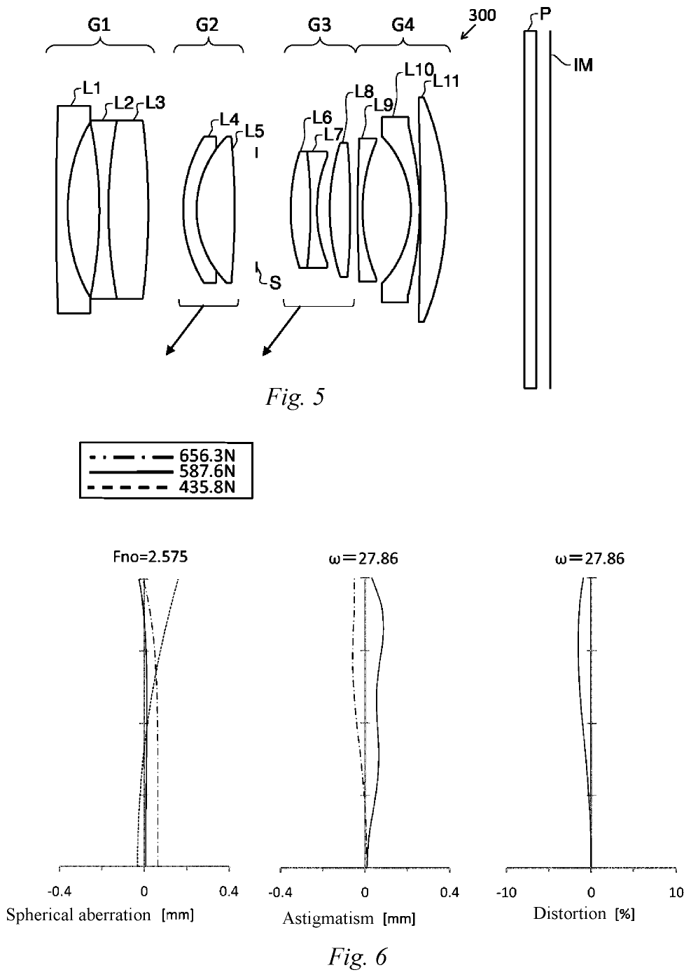

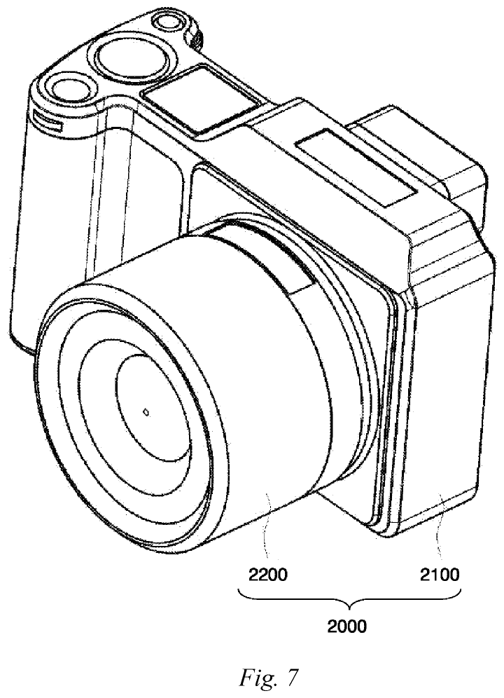

FIG. 6 shows spherical aberration, astigmatism, and distortion of the lens system 300 in a state of being in focus on a subject at infinity. In the spherical aberration diagram, a dot-dash line indicates the c-line (656.27 nm) value, a solid line indicates the d line (587.56 nm) value, and a dashed line indicates the g line (435.84 nm) value. In the astigmatism diagram, a solid line indicates the d-line sagittal image plane value, and a dashed line indicates the d-line meridional image plane value. In the distortion diagram, the d-line value is shown. Each of these aberration diagrams makes clear that the various aberrations can be favorably corrected in the lens system 300, and that the lens system 300 can provide superior imaging performance.

Table 10 shows the corresponding values of the conditional expressions (1) to (9) in the lens systems of Example 1 to Example 3.

TABLE 10

| | Conditional | Conditional | Conditional | Conditional | Conditional |
|---|---|---|---|---|---|
| | expression (1) | expression (2) | expression (3) | expression (4) | expression (5) |
| Example 1 | 1.33 | 1.48 | 0.9 | 1.41 | 1.00 |
| Example 2 | 1.44 | 1.17 | 0. 88 | 2.00 | 1.12 |
| Example 3 | 0.98 | 1.28 | 0.81 | 1.54 | 1.00 |
| | Conditional | Conditional | Conditional | Conditional | |
| | expression (6) | expression (7) | expression (8) | expression (9) | |
| Example 1 | 0.76 | 0.66 | 2. 80 | 1.43 | |
| Example 2 | 0.75 | 0.66 | 2.76 | 1.42 | |
| Example 3 | 0.80 | 0.65 | 2.80 | 1.40 | |

As described above, according to the lens systems of the above examples, it is possible to provide a lens system having a large image circle, a short overall length, and a high performance. Further, it is possible to provide a lens system in which the movable lens group is lightweight and focusing can be performed at high speed. The lens systems of the above examples are compact and have high optical performance while being applicable to an image capturing lens having a large image size.

Any combination of the configurations of the above-mentioned lens systems is possible, and can be appropriately and selectively used according to the required specifications. For example, the lens systems according to the above examples satisfy the conditional expressions (1) to (9), (1-1), (8-1) and (9-1), may satisfy any one of the conditional expressions (1) to (9), (1-1), (8-1) and (9-1), and may satisfy any combination of these conditional expressions.

Although the present disclosure has been described above with reference to the embodiments and examples, the present disclosure is not limited to the above embodiment and examples, and various modifications are possible. For example, the radius of curvature, surface spacing, refractive index, and Abbe number of each lens are not limited to the values shown in each of the above examples, and other values can be used.

The lens system according to the disclosure can be applied to a lens system for an image capturing apparatus such as a digital camera or a video camera. The lens system according to the disclosure can be applied to a lens system that does not have a zoom mechanism. The lens system according to the disclosure can be applied to a lens system of an aerial camera and a surveillance camera. The lens system according to the disclosure can be applied to an image capturing lens comprised in a non-interchangeable-lens image capturing apparatus. The lens system according to the disclosure can be applied to an interchangeable lens of an interchangeable lens camera such as a single-lens reflex camera.

For example, in the image capturing lens described in Patent Document 1 above, a method of moving the entire lens system on the optical axis can be applied. However, since the movement weight of the focus lens group becomes heavy, it becomes difficult to drive the electric focus lens for auto focus, which has become the mainstream in recent years. In addition, since the overall optical length changes during focusing, there will be obstacles in the processing of photography. Therefore, a floating focus is used to maintain high optical performance in photography from infinity to close range. The lens described in Patent Document 2 above solves part of the problem of the Patent Document 1 above, since the positive lens group is the first lens group, it is difficult to reduce the size of the lens and correct the aberration when the angle is widened. Further, as the weight of the front lens increases, the weight balance at the time of photography deteriorates. The configuration of the floating group in Patent Document 2 is a group configuration of a negative refractive power and a positive refractive power, whereas in the lens systems according to the above embodiment, a high lens performance can be maintained by symmetrically arranging a lens group having a positive refractive power and a lens group having a positive refractive power with respect to a stop.

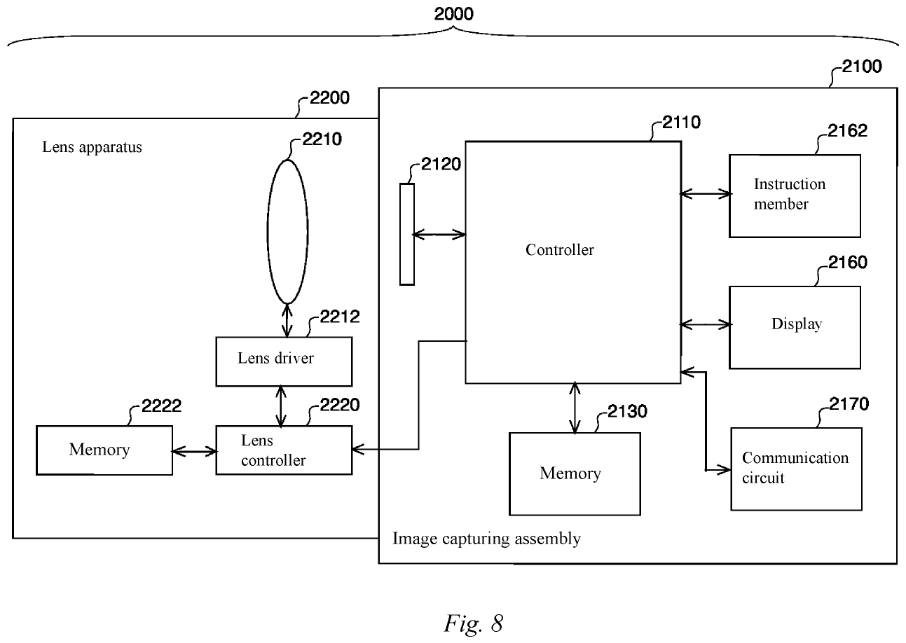

FIG. 7 shows an example of an external perspective view of an image capturing apparatus 2000 comprising the lens system according to the disclosure. FIG. 8 is a diagram showing a functional block of the image capturing apparatus 2000.

The image capturing apparatus 2000 comprises an image capturing assembly 2100 and a lens apparatus 2200. The image capturing assembly 2100 comprises an image sensor 2120, a controller 2110, a memory 2130, an instruction member 2162, a display 2160, and a communication circuit 2170.

The image sensor 2120 may include a CCD or CMOS. The image sensor 2120 receives light by means of a photographic lens system 2210 comprised in the lens apparatus 2200. The image sensor 2120 outputs image data of an optical image formed by means of the photographic lens system 2210 to the controller 2110. The photographic lens system 2210 comprises the lens system according to the above-mentioned embodiment.

The controller 2110 may include a microprocessor such as a CPU or an MPU, and a microcontroller such as an MCU, or the like. The memory 2130 may be a computer-readable recording medium and may include at least one of flash memories such as an SRAM, a DRAM, an EPROM, an EEPROM, and a USB memory. The controller 2110 corresponds to a circuit. The memory 2130 stores a program or the like necessary for the controller 2110 to control the image sensor 2120 or the like. The memory 2130 may be provided inside the housing of the image capturing apparatus 2000. The memory 2130 may be provided so as to be removable from the housing of the image capturing apparatus 2000.

The instruction member 2162 is a user interface that receives an instruction from a user for the image capturing apparatus 2000. The display 2160 displays an image captured by the image sensor 2120, and processed by the controller 2110, various setting information of the image capturing apparatus 2000, and the like. The display 2160 may include a touch panel.

The controller 2110 controls the lens apparatus 2200 and the image sensor 2120. For example, the controller 2110 controls the focal position and focal length of the photographic lens system 2210. The controller 2110 outputs, on the basis of information indicating an instruction from a user, a control command to the lens controller 2220 comprised in the lens apparatus 2200, so as to control the lens apparatus 2200.

The lens apparatus 2200 comprises the photographic lens system 2210, a lens driver 2212, the lens controller 2220, and a memory 2222. At least a part of the lenses included in the photographic lens system 2210 is arranged such that same can move along an optical axis of the photographic lens system 2210. The lens apparatus 2200 may be an interchangeable lens that is detachably provided with respect to the image capturing assembly 2100.

The lens driver 2212 moves at least a part of the lenses comprised in the photographic lens system 2210 along the optical axis of the photographic lens system 2210. The lens controller 2220 drives the lens driver 2212 according to a lens control command from the image capturing assembly 2100 to move at least a part of the lenses comprised in the photographic lens system 2210 along an optical axis direction, so as to perform at least one of a zoom operation and a focus operation. The lens control command is, for example, a zoom control command, a focus control command, and the like.

The lens driver 2212 may include a voice coil motor (VCM) that moves at least a part or all of the plurality of photographic lens systems 2210 in the optical axis direction. The lens driver 2212 may include an electric motor such as a DC motor, a coreless motor, or an ultrasonic motor. The lens driver 2212 can transmit power from the electric motor to at least a part or all of the plurality of photographic lens systems 2210 by means of mechanism members such as cam rings and guide shafts, and move at least a part of the lenses comprised in the photographic lens system 2210 along the optical axis.

The memory 2222 stores control values for focus lenses and zoom lenses that moved by the lens driver 2212. The memory 2222 may include at least one of flash memories such as an SRAM, a DRAM, an EPROM, an EEPROM, and a USB memory.

The controller 2110 outputs, on the basis of information indicating an instruction from a user acquired by the instruction member 2162 or the like, a control command to the image sensor 2120, so as to perform control including the control of the imaging operation on the image sensor 2120. The controller 2110 acquires an image captured by the image sensor 2120. The controller 2110 performs image processing on the image acquired from the image sensor 2120 and stores same in the memory 2130.

The communication circuit 2170 is responsible for communication with the external. The communication circuit 2170 transmits information generated by the controller 2110 to the external over a communication network. The communication circuit 2170 provides the controller 2110 with information received from the external over the communication network.

Although the present disclosure has been explained using the embodiments, the technical scope of the present disclosure is not limited to the scope described in the above embodiments. It will be apparent to a person skilled in the art that various modifications or improvements can be made with regard to the above embodiments. It is apparent from the description of claims that embodiments with such modifications or improvements can be included in the technical scope of the present disclosure.

It should be noted that the order of carrying out each instance of processing, such as an operation, procedure, step, and stage in an apparatus, system, program, and method shown in claims, description, and drawings may be implemented in any order unless otherwise indicated by “before” and “prior,” etc., and that the output of the previous instance of processing is not used in subsequent processing. Operation flows in claims, description, and drawings are described using “first,” “next,” and the like for the sake of convenience, but it does not mean that the flows are necessarily to be performed in this order.

### DESCRIPTION OF THE REFERENCE NUMERALS

100, 200, 300 Lens system

2000 Image capturing apparatus, 2100 Image capturing assembly, 2110 Controller, 2120 Image sensor, 2130 Memory, 2160 Display, 2162 Instruction member, 2170 Communication circuit, 2200 Lens apparatus, 2210 Photographic lens system, 2212 Lens driver, 2220 Lens controller, 2222 Memory

What is claimed is:

1. A lens system comprising:
a first lens group having a negative refractive power;
a second lens group having a positive refractive power;
a third lens group having a positive refractive power; and
a fourth lens group having a negative refractive power;
wherein:
the first lens group, the second lens group, the third lens group, and the fourth lens group are arranged in order from an object side of the lens system;
during a change from focusing on a first object to focusing on a second object closer to the lens system than the first object, at least the second lens group and the third lens group move along an optical axis toward the object side; and
0.7<|f4/f|<2.0 is satisfied, where f represents a focal length of the lens system, and f4 represents a focal length of the fourth lens group.

2. The lens system according to claim 1, wherein:
the second lens group includes a first cemented lens and the third lens group includes a second cemented lens; and
0.9<f2/f<2.0 and 0.5<f3/f<1.4 are satisfied, where f2 represents a focal length of the second lens group, and f3 represents a focal length of the third lens group.

3. The lens system according to claim 2, wherein:
the first lens group includes a first aspherical lens having a negative refractive power and the fourth lens group includes a second aspherical lens having a negative refractive power; and
1.0<|f_1asp/f|<2.5 and 0.6<|f_4asp/f|<2.2 are satisfied, where f_1asp represents a focal length of the first aspherical lens, and f_4asp represents a focal length of the second aspherical lens.

4. The lens system according to claim 2, wherein:
the first lens group includes a first aspherical lens having a negative refractive power and the fourth lens group includes a second aspherical lens having a negative refractive power; and
0.5<d_1asp/f<0.95 and 0.4<d_4asp/f<0.95 are satisfied, where d_1asp represents a distance from a stop to the first aspherical lens, and d_4asp represents a distance from the stop to the second aspherical lens.

5. The lens system according to claim 2, wherein 2.4<TL/Y<3.6 is satisfied, where TL represents a back focal length of the lens system, and Y represents a maximum image height.

6. The lens system according to claim 2, wherein 1.0<EPD/Y<1.7 is satisfied, where EPD represents an exit pupil distance of the lens system, and Y represents a maximum image height.

7. The lens system according to claim 1, wherein:
the first lens group includes a first aspherical lens having a negative refractive power and the fourth lens group includes a second aspherical lens having a negative refractive power; and
1.0<|f_1asp/f|<2.5 and 0.6<|f_4asp/f|<2.2 are satisfied, where f_1asp represents a focal length of the first aspherical lens, and f_4asp represents a focal length of the second aspherical lens.

8. The lens system according to claim 1, wherein:
the first lens group includes a first aspherical lens having a negative refractive power and the fourth lens group includes a second aspherical lens having a negative refractive power; and
0.5<d_1asp/f<0.95 and 0.4<d_4asp/f<0.95 are satisfied, where d_1asp represents a distance from a stop to the first aspherical lens, and d_4asp represents a distance from the stop to the second aspherical lens.

9. The lens system according to claim 1, wherein 2.4<TL/Y<3.6 is satisfied, where TL represents a back focal length of the lens system, and Y represents a maximum image height.

10. The lens system according to claim 1, wherein 1.0<EPD/Y<1.7 is satisfied, where EPD represents an exit pupil distance of the lens system, and Y represents a maximum image height.

11. The lens system according to claim 1, wherein the first lens group includes a cemented lens including three lenses.

12. The lens system according to claim 1, wherein the second lens group includes a cemented lens including two lenses.

13. The lens system according to claim 1, wherein the third lens group includes a cemented lens including three lenses.

14. The lens system according to claim 1, wherein the fourth lens group includes three meniscus lenses.

15. The lens system according to claim 1, wherein the first lens group includes a meniscus lens or a biconcave lens.

16. The lens system according to claim 15, wherein the meniscus lens includes a negative meniscus lens or the biconcave lens includes a biconcave negative lens.

17. The lens system according to claim 1, wherein the fourth lens group includes three meniscus lenses.

18. The lens system according to claim 1, wherein the fourth lens group includes two negative meniscus lenses and a positive meniscus lens.

19. An image capturing apparatus comprising:
a lens system including:
a first lens group having a negative refractive power;
a second lens group having a positive refractive power;
a third lens group having a positive refractive power; and
a fourth lens group having a negative refractive power;
wherein:
the first lens group, the second lens group, the third lens group, and the fourth lens group are arranged in order from an object side of the lens system;
during a change from focusing on a first object to focusing on a second object closer to the lens system than the first object, at least the second lens group and the third lens group move along an optical axis toward the object side; and
0.7<|f4/f|<2.0 is satisfied, where f represents a focal length of the lens system, and f4 represents a focal length of the fourth lens group; and
an image sensor.

20. The image capturing apparatus of claim 19, wherein:
the second lens group includes a first cemented lens and the third lens group includes a second cemented lens; and
0.9<f2/f<2.0 and 0.5<f3/f<1.4 are satisfied, where f2 represents a focal length of the second lens group, and f3 represents a focal length of the third lens group.
